(19) United States
(12) Patent Application Publication
(10) Pub. No.: US 2024/0211654 A1
(43) Pub. Date: Jun. 27, 2024

(54) METHOD AND SYSTEM FOR DETERMINING INSTALLATION POSITION OF THYRISTOR CONTROLLED PHASE SHIFTER, MEDIUM AND COMPUTING DEVICE

(71) Applicants: STATE GRID JIANGSU ELECTRIC POWER RESEARCH INSTITUTE, Nanjing, Jiangsu (CN); JIANGSU ELECTRIC POWER RESEARCH INSTITUTE CO., LTD., Nanjing, Jiangsu (CN)

(72) Inventors: Qun LI, Nanjing, Jiangsu (CN); Ningyu ZHANG, Nanjing, Jiangsu (CN); Jing CHEN, Nanjing, Jiangsu (CN); Bing CHEN, Nanjing, Jiangsu (CN); Jiankun LIU, Nanjing, Jiangsu (CN); Xinyao ZHU, Nanjing, Jiangsu (CN); Xu WANG, Nanjing, Jiangsu (CN)

(73) Assignees: STATE GRID JIANGSU ELECTRIC POWER RESEARCH INSTITUTE, Nanjing, Jiangsu (CN); JIANGSU ELECTRIC POWER RESEARCH INSTITUTE CO., LTD., Nanjing, Jiangsu (CN)

(21) Appl. No.: 18/556,347

(22) PCT Filed: Feb. 10, 2022
(86) PCT No.: PCT/CN2022/075833

§ 371 Date: Oct. 20, 2023

(30) Foreign Application Priority Data
Jul. 1, 2021 (CN) 202110750701.7

(51) Int. Cl. G06F 30/20; G01R 31/58; G06F 113/04; H02J 3/18

(52) U.S. Cl. CPC G06F 30/20; G01R 31/58; H02J 3/1878; G06F 2113/04; H02J 2203/10

(57) ABSTRACT

Disclosed are a method and system for determining the installation position of a thyristor controlled phase shifter, a medium and a computing device. The installation position of a thyristor controlled phase shifter can be determined according to the variation of the voltage stability index of a power system before and after the thyristor controlled phase shifter is installed, thus providing technical support for the selection of the installation position of the thyristor controlled phase shifter in a power grid.

### FIELD

The invention relates to a method and system for determining the installation position of a thyristor controlled phase shifter, a medium and a computing device, and belongs to the technical field of power system operation and control.

### BACKGROUND

With the rapid development of economy, the electrical load in China keeps increasing rapidly year by year, and the power system is approaching its operating limit gradually. How to fully exploit potentialities under the existing grid structure to guarantee safe operation of the power system has become an undertaking that should be taken into consideration by electrical technicians.

Voltage stability is the capacity to avoid voltage collapses of the power system under disturbance. In recent years, many widespread blackouts were caused by voltage collapses around the world, indicating that the voltage stability not only concerns the power supply quality, but also a major issue relating to the safe and economic operation of large systems. Thyristor controlled phase shifter (TCPST), as a novel power control device, can effectively improve the flow distribution in a system on the premise of not changing the original grid structure, thus improving the voltage stability of the system. However, at present, the thyristor controlled phase shifter is high in cost and has distinct flow control effects at different positions of a power grid. So, a method for determining the installation position of the thyristor controlled phase shifter is urgently needed now.

### SUMMARY

The invention provides a method and system for determining the installation position of a thyristor controlled phase shifter, a medium, and a computing device to solve the problems disclosed in the description of related art.

The technical solution adopted by the invention to solve the abovementioned problems is as follows:

A method for determining the installation position of a thyristor controlled phase shifter comprises:
Calculating voltage stability indexes of load nodes of a power system before a thyristor controlled phase shifter is installed;
Calculating, according to the voltage stability indexes of the load nodes obtained before the thyristor controlled phase shifter is installed, a voltage stability index of the power system before the thyristor controlled phase shifter is installed; and
Traversing the load nodes according to the voltage stability indexes of the load nodes and a preset rule, calculating the voltage stability index of the power system after the thyristor controlled phase shifter is installed at the load nodes, taking the corresponding load node as an installation position of the thyristor controlled phase shifter if the voltage stability index of the power system before the thyristor controlled phase shifter is installed is greater than the voltage stability index of the power system after the thyristor controlled phase shifter is installed, and ending the traversing.

A formula for calculating the voltage stability indexes of the load nodes is:

$${L}_{j} = \vert \frac{\dot{{S}_{j}^{+}}}{{Y}_{jj}^{*} {V}_{j}^{2}} \vert$$

Where, Lⱼ is the voltage stability index of the load node j, \dot{S}ⱼ⁺ is an equivalent power allocated to the load node j by the power system, Y*ⱼⱼ is a conjugate of self-admittance of the load node j, Yⱼⱼ is self-admittance of the load node j, and Vⱼ is a voltage of the load node j.

The voltage stability index of the power system is a set of the voltage stability indexes of all load nodes.

The preset rule is traversing the load nodes in a descending order of the voltage stability indexes of the load nodes.

A system for determining the installation position of a thyristor controlled phase shifter comprises:
Anode calculation module configured to calculate voltage stability indexes of load nodes of a power system before a thyristor controlled phase shifter is installed;
A system calculation module configured to calculate, according to the voltage stability indexes of the load nodes obtained before the thyristor controlled phase shifter is installed, a voltage stability index of the power system before the thyristor controlled phase shifter is installed; and
A traversing module configured to traverse the load nodes according to the voltage stability indexes of the load nodes and a preset rule, calculate the voltage stability index of the power system after the thyristor controlled phase shifter is installed at the load nodes, take the corresponding load node as an installation position of the thyristor controlled phase shifter if the voltage stability index of the power system before the thyristor controlled phase shifter is installed is greater than the voltage stability index of the power system after the thyristor controlled phase shifter is installed, and end the traversing.

A formula for calculating the voltage stability indexes of the load nodes is:

$${L}_{j} = \vert \frac{\dot{{S}_{j}^{+}}}{{Y}_{jj}^{*} {V}_{j}^{2}} \vert$$

Where, Lⱼ is the voltage stability index of the load node j, \dot{S}ⱼ⁺ is an equivalent power allocated to the load node j by the power system, Y*ⱼⱼ is a conjugate of self-admittance of the load node j, Yⱼⱼ is self-admittance of the load node j, and Vⱼ is a voltage of the load node j.

The voltage stability index of the power system is a set of the voltage stability indexes of all load nodes.

The preset rule is traversing the load nodes in a descending order of the voltage stability indexes of the load nodes.

A computer-readable storage medium having one or more programs stored therein, wherein the one or more programs comprise instructions, and when the instructions are executed by a computing device, the computing device implements the method for determining the installation position of a thyristor controlled phase shifter.

A computing device comprises one or more processors, one or more memories, and one or more programs, wherein the one or more programs are stored in the one or more memories and are configured to be executed by the one or more memories, and the one or more programs comprise instructions for implementing the method for determining the installation position of a thyristor controlled phase shifter.

The invention has the following beneficial effects: the installation position of the thyristor controlled phase shifter can be determined according to the variation of the voltage stability index of the power system before and after the thyristor controlled phase shifter is installed, thus providing technical support for the selection of the installation position of the thyristor controlled phase shifter in a power grid.

### BRIEF DESCRIPTION OF THE DRAWINGS

FIG. 1 is a flow diagram of a method according to the invention;

FIG. 2 is a structural view of a power system with three generators and nine load nodes;

FIG. 3 is a voltage graph before a thyristor controlled phase shifter is installed;

FIG. 4 is a voltage graph after a thyristor controlled phase shifter is installed.

### DETAILED DESCRIPTION

The invention will be further described below in conjunction with accompanying drawings. The following embodiments are merely used for more clearly explaining the technical solutions of the invention, and are not intended to limit the protection scope of the invention.

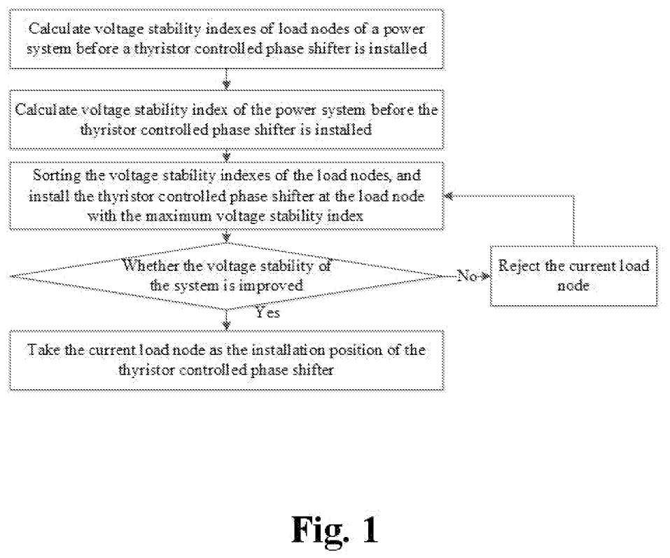

As shown in FIG. 1, a method for determining the installation position of a thyristor controlled phase shifter comprises:
Step 1: voltage stability indexes of load nodes of a power system are calculated before a thyristor controlled phase shifter is installed;
Step 2: according to the voltage stability indexes of the load nodes obtained before the thyristor controlled phase shifter is installed, a voltage stability index of the power system is calculated before the thyristor controlled phase shifter is installed; and
Step 3: the load nodes are traversed according to the voltage stability indexes of the load nodes and a preset rule; the voltage stability index of the power system after the thyristor controlled phase shifter is installed at the load nodes is calculated; if the voltage stability index of the power system before the thyristor controlled phase shifter is installed is greater than the voltage stability index of the power system after the thyristor controlled phase shifter is installed, the corresponding load node is taken as the installation position of the thyristor controlled phase shifter, and traversing is ended.

According to the method for determining the installation position of a thyristor controlled phase shifter, the voltage stability indexes of the load nodes are calculated to determine positions with weak voltage stability, and the installation position of the thyristor controlled phase shifter is determined according to the variation of the voltage stability index of the power system before and after the thyristor controlled phase shifter is installed, such that technical support is provided for the selection of the installation position of the thyristor controlled phase shifter in a power grid.

Before the voltage stability indexes of the load nodes are calculated, the grid framework, load value, unit parameters and the like of a power system are obtained, and a network equation of the power system is constructed according to obtained data, wherein the network equation of the power system is specifically as follows:

$$[ \begin{matrix}\dot{{I}_{G}} \\ \dot{{I}_{L}}\end{matrix} ] = [ \begin{matrix}{Y}_{GG} & {Y}_{GL} \\ {Y}_{LG} & {Y}_{LL}\end{matrix} ] [ \begin{matrix}\dot{{U}_{G}} \\ \dot{{U}_{L}}\end{matrix} ]$$

Where, \dot{U}_{G}, İ_{G} are a voltage vector and a current vector of generator nodes in the power system respectively, \dot{U}_{L}, İ_{L} are a voltage vector and a current vector of load nodes in the power system respectively, and Y_{GG}, Y_{GL}, Y_{LG}, Y_{LL} are sub-matrixes of an admittance matrix of the power system partitioned by a generator node set and a load node set.

Assume a load participation factor matrix is defined as F_{LG}=−Y_{LL}⁻¹Y_{LG}, based on the network equation of the power system, a voltage vector expression for any one load node in a power grid is:

$$\dot{{U}_{j}} = {\sum }_{{i ∈ {α}_{L}}_{j ∈ {α}_{L}}} {Z}_{ji} \dot{{I}_{i}} + {\sum }_{{k ∈ {α}_{G}}_{j ∈ {α}_{L}}} {F}_{jk} \dot{{U}_{Gk}}$$

Where, \dot{U}ⱼ is the voltage vector of the load node j, α_{G}, α_{L} are the generator node set and the load node set respectively, Zⱼᵢ is a mutual impedance between load nodes i and j, İᵢ is the current vector of the load node i, \dot{U}_{Gk} is the voltage vector of the generator node k, and Fⱼₖ is an element in the j^{th} row and the k^{th} column of F_{LG};

Based on the voltage vector expression, voltage stability indexes of the load nodes are obtained:

$${L}_{j} = \vert 1 + \frac{\dot{{V}_{0 j}}}{\dot{{V}_{j}}} \vert = \vert \frac{\dot{{S}_{j}^{+}}}{{Y}_{jj}^{*} {V}_{j}^{2}} \vert$$

Where, Lⱼ is the voltage stability index of the load node j, \dot{S}ⱼ⁺ is an equivalent power allocated to the load node j by the power system, Y*ⱼⱼ is a conjugate of self-admittance of the load node j, Yⱼⱼ is self-admittance of the load node j, Vⱼ is a voltage of the load node j, \dot{V}₀ⱼ is an equivalent voltage allocated to the load node j by the power system,

$$\dot{{V}_{0 j}} = - {\sum }_{k ∈ {α}_{G}} {F}_{jk} \dot{{V}_{k}} ,$$

and \dot{V}ₖ is a voltage of generators.

The voltage stability indexes of the load nodes are all local voltage stability indexes, and the voltage stability index of the power system is a set of the voltage stability indexes of all the load nodes, that is,

$${L}_{sys} = [ {L}_{1} , {L}_{2} , … , {L}_{n} ] , n ∈ {α}_{L} .$$

The voltage stability indexes of the load nodes reflect the voltage stability of the load nodes. The greater the voltage stability indexes, the lower the voltage stability, and the larger the possibility of a voltage collapse. So, the voltage stability indexes of the load nodes are sorted in a descending order, and al the load nodes are traversed in the descending order of the voltage stability indexes of the load nodes.

The thyristor controlled phase shifter is installed at the load nodes, and the voltage stability index of the power system after the thyristor controlled phase shifter is installed is calculated specially as follows:
(1) A flow equation in the presence of the thyristor controlled phase shifter is constructed, and the flow in the presence of the thyristor controlled phase shifter is calculated:

$$\{ \begin{matrix}{P}_{l} + Δ P - {V}_{l} {\sum }_{m ∈ l} {V}_{m} ( {G}_{lm} cos {θ}_{lm} + {B}_{lm} sin {θ}_{lm} ) = 0 \\ {Q}_{l} + Δ Q - {V}_{l} {\sum }_{m ∈ l} {V}_{m} ( {G}_{lm} sin {θ}_{lm} + {B}_{lm} cos {θ}_{lm} ) = 0\end{matrix}$$

Where, P₁, Q₁ are set values of a reactive power and an active power of a load node l, ΔP, ΔQ are an equivalent active power and an equivalent reactive power injected into the load node l by the thyristor controlled phase shifter, Vₗ, Vₘ are voltages of load nodes l and m at two ends of a circuit where the thyristor controlled phase shifter is installed, Bₗₘ, Gₗₘ are electrical susceptance and electric conductance of the circuit, θₗₘ is a phase angle difference between the two ends of the circuit, and l=1, 2, . . . , n;
(2) After the power flow in the presence of the thyristor controlled phase shifter is calculated, the voltage stability index of the power system is obtained after the thyristor controlled phase shifter is installed;
Then, the variation of the voltage stability index of the power system before and after the thyristor controlled phase shifter is installed is calculated:

$$Δ {L}_{s} = {L}_{sys}^{′} - {L}_{sys}^{″}$$

Where, ΔLₛ is the variation of the voltage stability index of the power system before and after the thyristor controlled phase shifter is installed, L′_{sys} is voltage stability index of the SYS power system before the thyristor controlled phase shifter is installed, and L_{sys}^{ff} is the voltage stability index of the power system before and after the thyristor controlled phase shifter is installed;
A greater ΔLₛ indicates a better installation position of the thyristor controlled phase shifter, and a smaller ΔLₛ indicates that a poorer installation position of the thyristor controlled phase shifter, that is, if L′_{sys} is greater than L_{sys}^{ff}, the position of the corresponding load node can be taken as an installation position of the thyristor controlled phase shifter, and traversing is ended; if ΔLₛ is not a positive number, the corresponding load node is eliminated, and traversing continues.

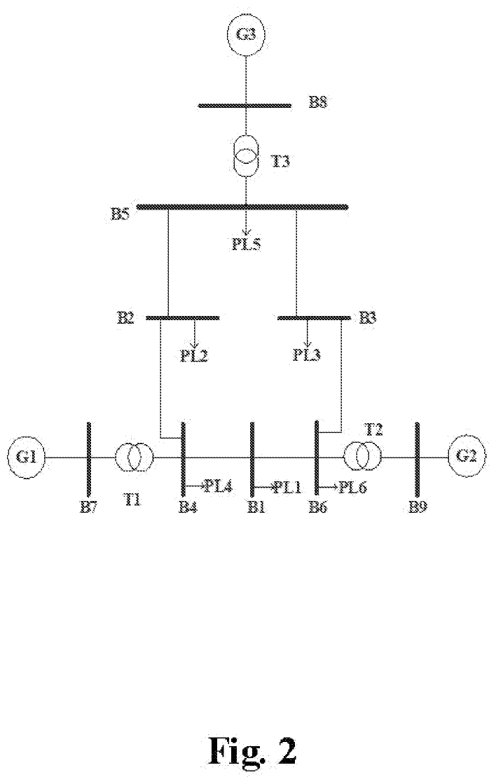

To verify the method, with the system shown by FIG. 2, in which G1-G3 are generator nodes, B1-B9 are lines, and PL1-PL6 are load nodes, as an example, the voltage stability indexes of the load nodes of the power system calculated before thyristor controlled phase shifter is installed are shown in Table 1:

Table 1 Voltage stability indexes of load nodes

| Load node | Voltage stability index |
|---|---|
| Node 1 | 0.0141 |
| Node 2 | 0.0162 |
| Node 3 | 0.0168 |
| Node 4 | 0.0114 |
| Node 5 | 0.0273 |
| Node 6 | 0.0106 |

It can be seen from Table 1 that the voltage stability indexes of all the load nodes in the system are less than 1, indicating that the voltage of the power system is a stable state currently.

It can be known, by comparing the voltage stability indexes of the load nodes in the system, that node 5 has the maximum index, indicating that node 5 has the lowest voltage stability and the highest possibility of a voltage collapse when the load in the power system is increased gradually, so a thyristor controlled phase shifter is installed at node 5, and specifically, the thyristor controlled phase shifter is installed between node 5 and node 8.

There two common types of thyristor controlled phase shifters: thyristor controlled phase shifters with a vertical regulation function and thyristor controlled phase shifters with a horizontal regulation function. The voltage stability indexes of the load nodes are calculated after different types of thyristor controlled phase shifters are installed, and are shown in Table 2:

Table 2 Voltage stability indexes in the presence of different types of thyristor controlled phase shifters

| | Voltage stability | Voltage stability |
|---|---|---|
| | index in the presence | index in the presence |
| | of a thyristor controlled | of a thyristor controlled |
| Load | phase shifter with the | phase shifter with the |
| node | vertical regulation function | horizontal regulation function |
| Node 1 | 0.0113 | 0.0179 |
| Node 2 | 0.0019 | 0.0144 |
| Node 3 | 0.0027 | 0.0170 |
| Node 4 | 0.0024 | 0.0116 |
| Node 5 | 0.0109 | 0.0195 |
| Node 6 | 0.0059 | 0.0128 |

It can be known, by comparing data in Table 2, that the voltage stability index of the power system after the thyristor controlled phase shifter with the vertical regulation function is installed is decreased by 60.1%, and the voltage stability index of the power system after the thyristor controlled phase shifter with the horizontal regulation function is installed is decreased by 28.6%, indicating that the voltage stability of the whole power system can be better improved by installing the thyristor controlled phase shifter with the vertical regulation function in the power system.

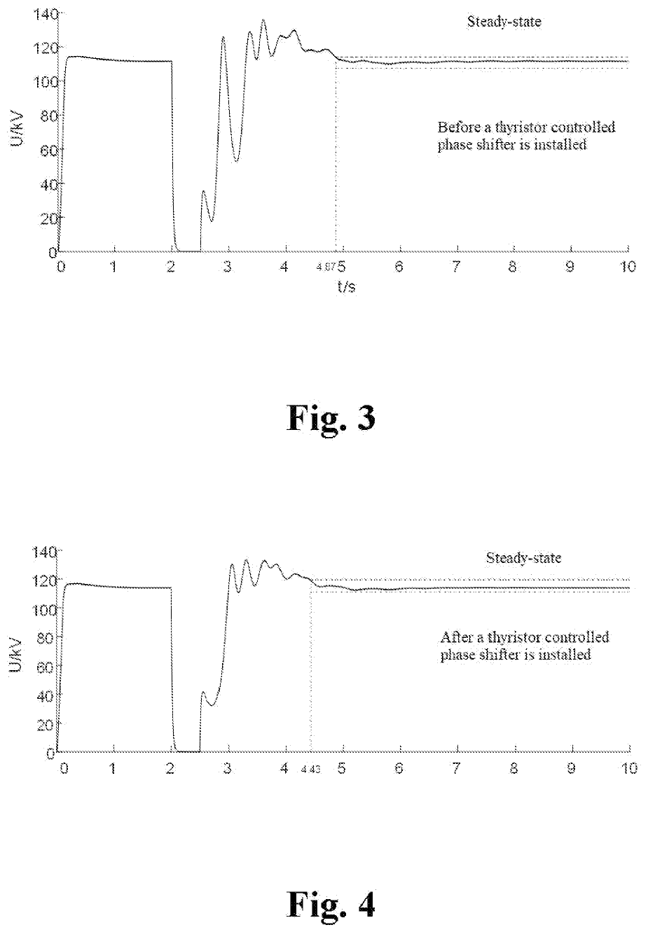

After the thyristor controlled phase shifter with the vertical regulation function is installed, a three-phase short-circuit fault is applied to node 5 (the fault occurs at 2 s and is removed at 2.5 s), and the voltage variation waveforms of load node 5 before and after the thyristor controlled phase shifter is installed are compared, as shown in FIG. 3 and FIG. 4. With the regulation time for returning the voltage of the power system to 2% of a steady-state value as a criterion, it can be seen from FIG. 3 and FIG. 4 that the original steady-state voltage of node 5 of the power system is 112 kV, the steady-state voltage of node 5 is 114 kV after the thyristor controlled phase shifter is installed, the regulation time of the system before the thyristor controlled phase shifter is installed is 2.87 s, and the regulation time of the system after before the thyristor controlled phase shifter is installed is 2.43 s, which is decreased by 0.44 s, proving that after the before the thyristor controlled phase shifter is installed, the anti-interference capacity of the whole system is remarkably improved, and the voltage stability of a power grid is greatly improved.

Therefore, the thyristor controlled phase shifter is installed at node 5 of the system (between node 5 and node 8), and other nodes will not be traversed anymore.

A software system corresponding to the abovementioned method, namely a method for determining the installation position of a thyristor controlled phase shifter, comprises:
A node calculation module configured to calculate voltage stability indexes of load nodes of a power system before a thyristor controlled phase shifter is installed;
Wherein, a formula for calculating the voltage stability indexes of the load nodes is:

$${L}_{j} = \vert \frac{\dot{{S}_{j}^{+}}}{{Y}_{jj}^{*} {V}_{j}^{2}} \vert$$

Where, Lⱼ is the voltage stability index of the load node j, \dot{S}ⱼ⁺ is an equivalent power allocated to the load node j by the power system, Y*ⱼⱼ is a conjugate of self-admittance of the load node j, Yⱼⱼ is self-admittance of the load node j, and Vⱼ is a voltage of the load node j;
a system calculation module configured to calculate, according to the voltage stability indexes of the load nodes obtained before the thyristor controlled phase shifter is installed, a voltage stability index of the power system before the thyristor controlled phase shifter is installed, wherein the voltage stability index of the power system is a set of the voltage stability indexes of all load nodes; and
A traversing module configured to traverse the load nodes according to the voltage stability indexes of the load nodes and a preset rule, calculate the voltage stability index of the power system after the thyristor controlled phase shifter is installed at the load nodes, take the corresponding load node as an installation position of the thyristor controlled phase shifter if the voltage stability index of the power system before the thyristor controlled phase shifter is installed is greater than the voltage stability index of the power system after the thyristor controlled phase shifter is installed, and end the traversing, wherein the preset rule is traversing the load nodes in a descending order of the voltage stability indexes of the load nodes.

A computer-readable storage medium having one or more programs stored therein, wherein the one or more programs comprise instructions, and when the instructions are executed by a computing device, the computing device implements the method for determining the installation position of a thyristor controlled phase shifter.

A computing device comprises one or more processors, one or more memories, and one or more programs, wherein the one or more programs are stored in the one or more memories and are configured to be executed by the one or more memories, and the one or more programs comprise instructions for implementing the method for determining the installation position of a thyristor controlled phase shifter.

Those skilled in the art should understand that the embodiments of the application can be provided as a method, a system or a computer program product. So, the application may be implemented as completely hardware embodiments, completely software embodiments, or embodiments combining software and hardware. In addition, the application may be in the form of a computer program product to be implemented on one or more computer-available storage media (including, but not limited to, a disk memory, a CD-ROM, and an optical memory) comprising computer-available program codes.

The application is described with reference to flow diagrams and/or block diagrams of the method, device (system) and computer program product of the embodiments of the application. It should be understood that each process and/or block in the flow diagram and/or block diagram and the combinations of processes and/or blocks in the flow diagram and/or block diagram can be implemented by computer program instructions. These computer program instructions can be configured in a general-purpose computer, a special-purpose computer, an embedded processor, or a processor of other programmable data processing terminals to create a machine, so that the instructions can be executed by the computer or the processor of other programmable data processing terminals to create a device for implementing one or more processes in the flow diagram and/or realizing specific functions in one or more blocks in the block diagram.

These computer program instructions may also be stored in a computer-readable memory that can guide the computer or other program data processing terminals to work in a specific manner, so that the instructions stored in the computer-readable memory can create a product including an instruction device, and the instruction device implements one or more processes in the flow diagram and/or realize specific functions in one or more blocks in the block diagrams.

These computer program instructions may also be loaded on a computer or other programmable data processing devices, such that the computer or other programmable devices can perform a series of operation steps to carry out processing realized by the computer, and the instructions executed on the computer or other programmable devices are used to perform steps for implementing one or more processes in the flow diagram and/or realizing specific functions in one or more blocks of the block diagram.

The above embodiments are merely preferred ones of the invention, and are not used to limit the invention. Any amendments, equivalent substitutions and improvements made based on the spirit and principle of the invention should fall within the scope of the claims of the invention to be granted.

What is claimed is:

1. A method for determining the installation position of a thyristor controlled phase shifter, comprising:
calculating voltage stability indexes of load nodes of a power system before a thyristor controlled phase shifter is installed;
calculating, according to the voltage stability indexes of the load nodes obtained before the thyristor controlled phase shifter is installed, a voltage stability index of the power system before the thyristor controlled phase shifter is installed; and
traversing the load nodes according to the voltage stability indexes of the load nodes and a preset rule, calculating the voltage stability index of the power system after the thyristor controlled phase shifter is installed at the load nodes, taking the corresponding load node as an installation position of the thyristor controlled phase shifter if the voltage stability index of the power system before the thyristor controlled phase shifter is installed is greater than the voltage stability index of the power system after the thyristor controlled phase shifter is installed, and ending the traversing.

2. The method for determining the installation position of a thyristor controlled phase shifter according to claim 1, wherein a formula for calculating the voltage stability indexes of the load nodes is:
$${L}_{j} = \vert \frac{\dot{{S}_{j}^{+}}}{{Y}_{jj}^{*} {V}_{j}^{2}} \vert$$
where, Lⱼ is the voltage stability index of the load node j, \dot{S}ⱼ⁺ is an equivalent power allocated to the load node j by the power system, Y*ⱼⱼ is a conjugate of self-admittance of the load node j, Yⱼⱼ is self-admittance of the load node j, and Vⱼ is a voltage of the load node j.

3. The method for determining the installation position of a thyristor controlled phase shifter according to claim 1, wherein the voltage stability index of the power system is a set of the voltage stability indexes of all load nodes.

4. The method for determining the installation position of a thyristor controlled phase shifter according to claim 1, wherein the preset rule is traversing the load nodes in a descending order of the voltage stability indexes of the load nodes.

5. A system for determining the installation position of a thyristor controlled phase shifter, comprising:
a node calculation module configured to calculate voltage stability indexes of load nodes of a power system before a thyristor controlled phase shifter is installed;
a system calculation module configured to calculate, according to the voltage stability indexes of the load nodes obtained before the thyristor controlled phase shifter is installed, a voltage stability index of the power system before the thyristor controlled phase shifter is installed; and
a traversing module configured to traverse the load nodes according to the voltage stability indexes of the load nodes and a preset rule, calculate the voltage stability index of the power system after the thyristor controlled phase shifter is installed at the load nodes, take the corresponding load node as an installation position of the thyristor controlled phase shifter if the voltage stability index of the power system before the thyristor controlled phase shifter is installed is greater than the voltage stability index of the power system after the thyristor controlled phase shifter is installed, and end the traversing.

6. The system for determining the installation position of a thyristor controlled phase shifter according to claim 5, wherein a formula for calculating the voltage stability indexes of the load nodes is:
$${L}_{j} = \vert \frac{\dot{{S}_{j}^{+}}}{{Y}_{jj}^{*} {V}_{j}^{2}} \vert$$
where, Lⱼ is the voltage stability index of the load node j, \dot{S}ⱼ⁺ is an equivalent power allocated to the load node j by the power system, Y*ⱼⱼ is a conjugate of self-admittance of the load node j, Yⱼⱼ is self-admittance of the load node j, and Vⱼ is a voltage of the load node j.

7. The system for determining the installation position of a thyristor controlled phase shifter according to claim 5, wherein the voltage stability index of the power system is a set of the voltage stability indexes of all load nodes.

8. The system for determining the installation position of a thyristor controlled phase shifter according to claim 5, wherein the preset rule is traversing the load nodes in a descending order of the voltage stability indexes of the load nodes.

9. A computer-readable storage medium having one or more programs stored therein, wherein the one or more programs comprise instructions, and when the instructions are executed by a computing device, the computing device implements the method for determining the installation position of a thyristor controlled phase shifter according to claim 1.

10. A computing device, comprising:
one or more processors, one or more memories, and one or more programs, wherein the one or more programs are stored in the one or more memories and are configured to be executed by the one or more memories, and the one or more programs comprise instructions for implementing the method for determining the installation position of a thyristor controlled phase shifter according to claim 1.
